(19) United States
(12) Patent Application Publication
(10) Pub. No.: US 2020/0088600 A1
(43) Pub. Date: Mar. 19, 2020

(54) Measuring System for Turbine Engine

(71) Applicant: SAFRAN AERO BOOSTERS SA, Herstal (BE)

(72) Inventors: Nicolas Raimarckers, Tourinne (Braives) (BE); Frederic Vallino, Seraing (BE)

(73) Assignee: SAFRAN AERO BOOSTERS SA, Herstal (BE)

(21) Appl. No.: 16/572,816

(22) Filed: Sep. 17, 2019

(30) Foreign Application Priority Data
Sep. 17, 2018 (BE) 2018/5632

(51) Int. Cl. G01L 19/00; G01K 7/22; G01L 9/00

(52) U.S. Cl. CPC G01L 19/0092; G01L 9/0052; G01K 7/22

(57) ABSTRACT

A measuring system for a turbine engine includes a piezoresistive sensor and an analysis module, the sensor and the module being such that the module can determine, from measuring two electrical voltages, a pressure value (p) and a temperature value (T) in the vicinity of the sensor. The sensor can include a Wheatstone bridge arranged on a flexible membrane.

This application claims priority under 35 U.S.C. § 119 to Belgium Patent Application No. 2018/5632, filed 17 Sep. 2018, titled “Measuring System for Turbine Engine” which is incorporated herein by reference for all purposes.

### BACKGROUND

### 1. Field of the Application

The present application relates to the field of axial turbine engine and more particularly the test benches for aircraft turbojets. More specifically, the present application relates to a pressure and temperature sensor and its use in such a bench

### 2. Description of Related Art

Document U.S. Pat. No. 7,159,401 B1 describes a pressure sensor for measuring properties of a flow of air in a turbojet engine. The sensor employs a piezoresistive technology which is also described in US 2015/0114128 A1 or US 2012/0014936 A1. Resistors (piezoresistors) are mounted on a membrane that deforms under the action of the pressure to which it is subjected. By measuring the resistances at a given moment (indirectly via a measurement of intensity), one can deduce the pressure applied on the membrane.

The behavior of the resistors can be affected by temperature variations. Thus, the document US 2015/0114128 A1 proposes an electric compensation circuit to correct the resistance values and thus to circumvent the issue related to the temperature.

The measurement of the temperature is generally performed by means of a thermocouple. Depending on the type of thermocouple used, the measurement accuracy is of about 0.2 to 3% of the measured temperature. In practice this represents an accuracy of 0.5° C. at best.

Thus, the measurement of pressure and temperature requires two sensors and two separate wiring. However, in some situations, such as for a turbojet engine test bench, hundreds of sensors are used and the multiplicity of wiring is problematic, in terms of size, cost, data exploitation, etc.

Temperature or pressure sensors may often positioned in a remote location from areas of interest. A problem of inertia then arises because the perceived pressures and temperatures are out of phase with the area of interest. In particular for a turbomachine, the remote measurement of the airflow does not allow high-frequency measurement that is exploitable.

Conversely, sensors that are closer to the air flow can disturb the flow, the measurement becoming intrusive.

Although great strides have been made in the area of test benches for aircraft turbojets, many shortcomings remain.

### DESCRIPTION OF THE DRAWINGS

FIG. 1 represents an axial turbomachine test bench according to the present application;

FIG. 2 illustrates an instrumented blade with sensors according to the present application;

FIG. 3 shows a sensor according to the present application;

FIG. 4 shows a first embodiment with a four-wire assembly;

FIG. 5 shows a second embodiment with a six-wire assembly;

FIGS. 6A and 6B describe sensor characteristic curves, namely temperature and pressure as a function of the measured voltages, respectively; and

FIG. 7 illustrates a method for determining pressure and temperature as a function of the measured voltages.

### DETAILED DESCRIPTION OF THE PREFERRED EMBODIMENT

The present application aims to overcome the difficulties of the state of the art and in particular to propose a means for measuring pressure and temperature which is less cumbersome and more precise than the known means.

The subject of the present application is a measurement system for a turbomachine, the system comprising a piezoresistive sensor and an analysis module, wherein the sensor and the module are connected by at least two pairs of conductors enabling the module to measure two electrical voltages.

According to preferred embodiment of the present application, the module is configured to determine a pressure value and a temperature value in the vicinity of the sensor from these two voltages. By “configured” is meant that it is provided with any electrical means, software, memory, screen, means of communication, etc., and/or that it is calibrated to transmit a pressure value and a temperature value from the two measured voltage signals. When the sensor is supplied with a defined current value, only the two voltage values are needed to determine the pressure and temperature.

The present application also relates to a sensor for the measuring system described above, the sensor comprising resistors arranged according to a Wheatstone bridge and being able to deliver two voltage signals.

In a preferred embodiment, the Wheatstone bridge comprises two parallel branches, each of the branches having two resistors in series and an intermediate point between the two resistors, the temperature being estimated from a voltage measurement at the terminals of two resistances of the same branch and the pressure being estimated, knowing the temperature, from a measurement of tension between the two intermediate points of the two branches.

According to preferred embodiment of the present application, the sensor is supplied with current. In other words, a current source supplies an electric current of defined intensity to the Wheatstone bridge, which is therefore not powered by a voltage source (battery, mains, etc.).

According to preferred embodiment of the present application, the resistors are arranged on a deformable membrane. The membrane may be silicon.

According to preferred embodiment of the present application, the sensor comprises a nozzle with a cavity, the nozzle being pierced to allow the fluidic contact of an air flow to be measured with the cavity.

One of the ends of the nozzle may thus include orifices for the fluidic contact of the membrane and the air flow. The other end is also open so that conductors from the Wheatstone bridge can join the analysis module.

According to preferred embodiment of the present application, the nozzle has a diameter of less than 3.5 mm, preferably less than 3 mm.

According to preferred embodiment of the present application, the sensor comprises 4 conductors able to connect the sensor to the analysis module. Thus, the two conductors that supply the current sensor can also be used for measuring one of the voltages.

According to preferred embodiment of the present application, the sensor comprises 6 conductors able to connect the sensor to the analysis module. In this way, a more precise measurement can be obtained because it overcomes the electrical resistance of the power cables of the bridge.

According to preferred embodiment of the present application, all the wires are grouped in a common sheath capable of being connected to the analysis module.

According to preferred embodiment of the present application, at least one of the resistors is a thermistor. This makes it possible to better underline the variations of temperatures via the variations of resistances.

The present application also relates to a method for determining the conditions in the vicinity of a piezoresistive sensor, remarkable in that it comprises a step of measuring two voltages and the determination, on the basis of these two measurements, of the pressure and temperature in the vicinity of the sensor.

According to preferred embodiment of the present application, the temperature is firstly estimated from a first voltage value, then the pressure is determined as a function of the estimated temperature and a second measured voltage.

According to preferred embodiment of the present application, the method employs a sensor as described above.

According to preferred embodiment of the present application, the sensor is positioned in contact with the air flow in a turbomachine.

According to preferred embodiment of the present application, the measurement step consists of a measurement at a frequency between 8 kHz and 100 kHz. Smaller ranges can be used as needed, from 8 to 24 kHz, from 24 to 60 kHz or from 60 to 100 kHz. For example, for a compressor equipped with a row of 80 blades rotating at 6000 rpm, the sensor “sees” 480,000 blades per minute, or 8,000 blades per second. In order to obtain a fine analysis of aerodynamic phenomena, it is necessary to provide several measurements per inter-vane passage, hence the ranges mentioned above.

The present application also relates to a method of calibrating a measuring system as described above, the method comprising a calibration step in which known pressures and/or temperatures are successively inflicted on the sensor and the voltages measured are associated with each pressure and/or temperature.

For this purpose, it is possible to provide successive pressure and temperature couples. Alternatively, it is possible to fix the temperature and to vary the pressure, and then fix the pressure and vary the temperature.

It is also possible to repeat the calibration for several intensity values feeding the bridge with current.

According to preferred embodiment of the present application, the method comprises a step of determining abacuses and/or approximate formulation of pressures and temperatures as a function of the measured voltages.

For example, for a given temperature, a linear or polynomial regression of the pressure as a function of the measured voltage can be obtained.

The present application also relates to a turbomachine test bench comprising a measuring system as described above and a sensor as described above, the sensor being disposed in the vicinity of the air flow in the compressor of the turbine engine.

According to preferred embodiment of the present application, the sensor is arranged in the vicinity of the leading edge of a stator blade.

According to preferred embodiment of the present application, the sensor is arranged in the vicinity of the leading edge of a rotor blade, the analysis module being preferably disposed in the turbomachine and having wireless communication elements. Indeed, telemetry means are necessary if the sensor is moving, to be able to transmit the information of the measured voltages or pressures and temperatures.

The present application also relates to a turbomachine equipped with such a measuring system or such a sensor. This turbomachine may be a test engine, on the ground (in or outside a test bench), mounted or not on an aircraft or on a flying aircraft.

The present application also relates to the use of such a sensor or such a turbomachine in an aircraft in flight.

In general, the advantageous embodiments of each object of the present application are also applicable to the other objects of the present application.

The sensor according to the present application is smaller than the two sensors necessary for measuring pressure and temperature. Thus, the introduction of the sensor into an instrumented turbojet engine is less tedious, especially given that an instrumented turbojet engine includes hundreds of sensors.

The small size is also advantageous because the measurement is less intrusive in the air flow.

Also, the wiring is simplified, less heavy, less bulky and cheaper.

In addition, the measurement can be made at high frequency and it is therefore possible to distinguish the pressure and temperature variations induced by the passage of a rotor blade in front of a stator blade.

The accuracy of the measurement is also significantly improved because it reaches accuracies of about 0.1° C. and 0.1% pressure.

The solutions presented in the present application also prevent any inertia effect when measuring pressure or temperature away from the points of interest. In practice, sensors that are positioned at a distance from the compressor can take up to 6 minutes to stabilize in temperature while the sensor of the present application allows a measurement directly to the points of interest without delay.

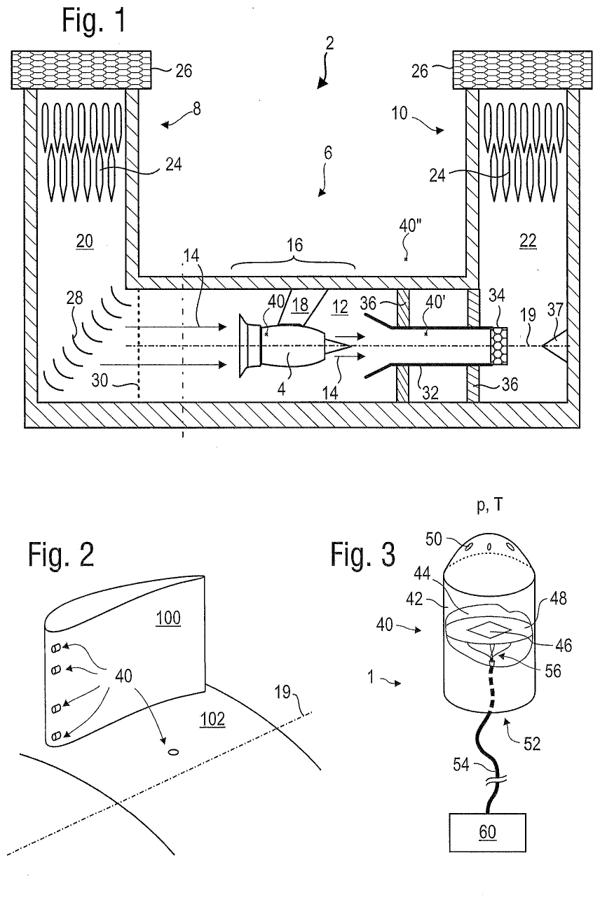

FIG. 1 is a simplified representation of a motor test bench 2, more particularly a test bench 2 for an aircraft turbojet engine 4. The test bench 2 could possibly receive a complete plane, or at least a part of plane.

The test bench 2 comprises a passage 6 with an inlet 8 and an outlet 10. The passage 6 comprises an essentially elongated corridor 12. Its length may be greater than or equal to 60 m. The length of the passage 12 allows the flow in a straight line of an air flow 14 by limiting the formation of vortices affecting the quality of the test.

In order to limit the resistance to flow through the passage 12, in particular the resistance opposing the entry of an air flow 14 into the turbomachine 4, the passage 12 may have an upper passage section or equal to 50 m². The air flow 14 passing through the test bench 2 can be driven by the turbomachine 4 itself during its test phase. An installation zone 16 of the turbomachine 4 is provided. The installation zone 16 may be an attachment zone of the turbomachine 4. It may be provided with a fastening system 18 to which the turbomachine 4 is attached during its test. The system 18 can extend vertically from the ceiling of the corridor 12, in the manner of a column or a pole. The system 18 makes it possible to mount the turbomachine 4 with an offset, and to center the latter with respect to the middle of the corridor 12, in particular with respect to a central axis 19 of the corridor 12.

The corridor 12 may be defined by vertical chimneys 20, 22 at the inlet 8 and at the outlet 10. They allow an air inlet and an exhaust, both vertical and in elevation with respect to the corridor 12. To reduce noise pollution, they may include sound baffles 24, or acoustic blades 24, for absorbing sound waves passively.

Complementary devices 26 may be present at the input 8 and at the output 10 to prevent reversals of flows, which would disturb the test conditions. The U-shape configuration is a non-limiting example of the general form of the test bench.

At the junction between the upstream chimney and the corridor 12, the bench 2 is equipped with a series of deflection blades 28. They make it possible to return the air coming down from the inlet chimney 20 in a horizontal direction. At the entrance to the corridor 12, the bench 2 optionally has a gate 30 for intercepting debris which would otherwise disturb the test and damage the turbomachine 4.

Downstream of the turbomachine 4, the bench 2 comprises a tube 32 collecting the air flow 14 propelled by the turbomachine 4 and the exhaust gas. The collector tube 32 contributes to absorbing the noise generated during the test. The collector tube 32 comprises a diffuser 34 at its outlet. The diffuser 34 may be in the outlet chimney 22.

The collecting tube 32 can be maintained in the bench 2 by means of two partitions 36. These partitions 36 extend vertically and transversely in the corridor 12. They form sealed separations, which make it possible to contain the stream 14 issued from the turbomachine 4.

To deflect the flow from the collector tube 32, and the diffuser 34, a cone 37 can be placed in the extension of the collector tube 32. It can be attached to a vertical wall at the end of the corridor 12. Its tip may coincide with the central axis 19.

The bench 2 also comprises a very large number of sensors 40, 40′, 40″. Some sensors may be inside the turbomachine, inside the bench or outside the bench.

A sensor 40 according to the present application may be disposed inside the turbomachine.

FIG. 2 illustrates a compressor blade 100, provided with several sensors 40 according to the present application, which measure the pressure and the temperature. The sensors 40 may be positioned on the leading edge of the blade 100. They may be protruding from, or may be flush with, the surface of the blade. By providing a plurality of radially spaced sensors 40, it is possible to measure a radial distribution of temperature and pressure over the vane, at each instant.

The blade 100 may be a compressor rotor blade or a stator blade. It can be variable in orientation (“VSV” for “variable stator vane”).

The blade may be supported by an inner shell 102. An alternative or complementary position of the sensor 40 is the ferrule 102. Alternatively or in addition, an outer shell may comprise a sensor 40.

FIG. 3 represents a measurement system 1 according to the present application with a sensor 40 according to the present application and an analysis module 60. The sensor 40 comprises a nozzle 42 defining an internal cavity 44 which accommodates the detection elements of the sensor 40, in this case an electrical circuit 46 supported by a membrane 48.

The nozzle 42 includes orifices 50 at one of its ends to fluidly connect the membrane 48 with the pressure and the temperature to be measured. At its other end, the nozzle 42 comprises an orifice 52 for connecting the nozzle 42 to atmospheric pressure. The membrane 48 therefore separates the pressure of the medium to be measured from the atmospheric pressure. The deformation of the membrane 48 is therefore a physical manifestation of the pressure at the orifices 50. By measuring this deformation through the electric circuit 46, it is therefore possible to evaluate the pressure.

The passage 52 can allow the passage of the cable 54 which connects the sensor 40 to the analysis module 60.

The cable 54 is a single sheath which comprises several conductors 56 connected to the electrical circuit 46.

The analysis module 60 includes all the means necessary to perform the analysis of electrical voltages (voltmeter, processor, memory, graphical interface, user interface, communication means, etc.).

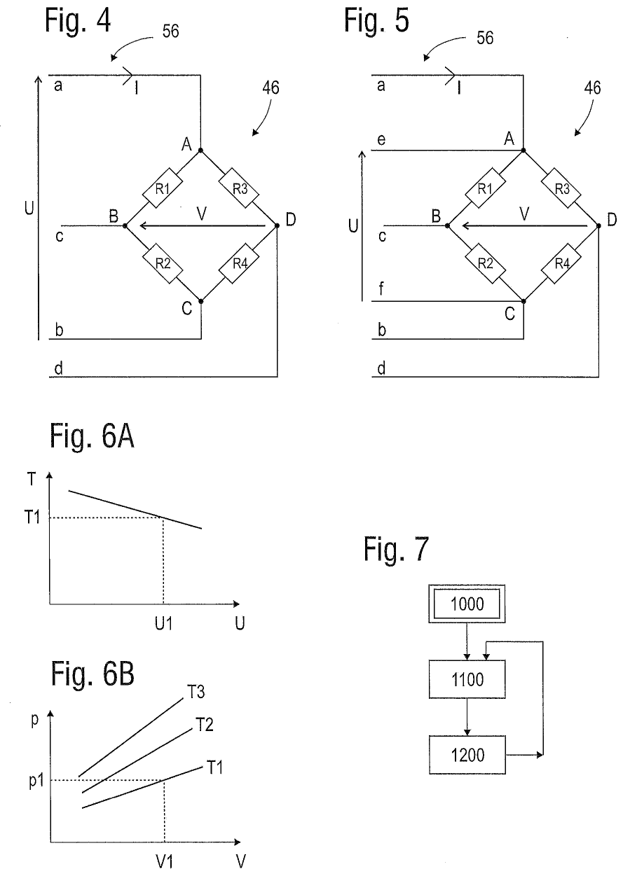

FIG. 4 describes in more detail the electrical circuit 46 in a “four-wire” version. This embodiment comprises four wires or conductors a, b, c, d and four resistors R1, R2, R3, R4 arranged according to a Wheatstone bridge. At least one of, and preferably all, resistors is/are piezoresistances and/or thermistors.

The conductors a and b are connected to a current supply source, which delivers an intensity I.

The conductors a and b are also connected to the analysis module to measure a voltage U between the points A and C. For a given intensity I, the value of U varies only with the temperature.

The conductors c and d are connected to the analysis module which measures the voltage V between the points B and D. For a given intensity I, the value of V varies as a function of the pressure and the temperature.

FIG. 5 depicts an arrangement according to a second embodiment. The electrical circuit 146 is partly identical to the circuit 46 and the reference signs are therefore similar. The circuit 146 however comprises two additional conductors, e and f. Unlike the circuit 46 of FIG. 4, the measurement of the voltage U is not carried out using the wires a and b but via the wires e and f. As the intensity is zero in the conductor e and f, the measurement of the voltage is more accurate because it circumvents the resistance of conductor a and b in the measurement. The “six-wire” version therefore has an advantage over the measurement accuracy even though it has the disadvantage of requiring two additional wires.

FIGS. 6A and 6B schematically describe the characteristics of the bridge as a function of temperature and pressure.

FIG. 6A describes an example of the measurement of the temperature as a function of the voltage U.

The resistors R1, R2, R3 and R4 form an equivalent resistance R_{eq}:

$${R}_{eq} = \frac{( R 1 + R 2 ) ( R 3 + R 4 )}{R 1 + R 2 + R 3 + R 4}$$

As the temperature increases, the resistance R_{eq} varies. In the example shown, the resistance increases with temperature but other variations are possible. The value of R_{eq} is independent of the pressure because the variations of the resistances as a function of the pressure on the membrane compensate each other. Over a range of given value, an approximation of the linear or polynomial type can be made.

Since U=R_{eq}*I, the variations of U are, for a given value of I, proportional to the variations of R_{eq}. There is thus a linear or polynomial relation between the temperature T and the value of U.

A particular operating point is shown in FIG. 6A: when the value U1 is measured for the voltage U, the temperature is equal to T1.

FIG. 6B describes the pressure variations as a function of the value of V. For a given temperature (T1, T2, T3), the pressure variations follow a curve that can be approximated by a straight line. After defining the temperature by the curve of FIG. 6A, the pressure can be determined by the appropriate curve of FIG. 6B. For example, for the value of T1 determined by FIG. 6A, the measurement of a value V1 of the voltage V gives a pressure which is p1.

FIG. 7 illustrates a method for determining pressure and temperature as a function of the measured voltages.

A first calibration step 1000 is performed before the first use of the measurement system.

Through calibration of the sensor, the different curves or their approximate formulations can be obtained. Calibration can be done for a fixed temperature value, by varying the pressure, or for a fixed value of pressure, by varying the temperature. Such manipulation may require placing the sensor in an expandable gas volume because at constant volume, the pressure and temperature variations are not independent from one another.

After the calibration 1000, a measurement step 1100 of U makes it possible to determine the temperature, and a measurement step 1200 of V makes it possible to determine the pressure.

It is understood that the measurements of U and V can be made simultaneously, the analyses of T and p being sequential.

The steps are repeated at a frequency of at least 8 kHz. The data is saved for later processing.

We claim:

1. A measuring system for a turbine engine, the measuring system comprising:
a piezoresistive sensor and an analysis module, wherein the piezoresistive sensor comprises:
resistors arranged as a Wheatstone bridge and is configured to deliver two voltage signals, the piezoresistive sensor and the analysis module being connected to each other by at least two pairs of conductors allowing the analysis module to measure simultaneously the two voltage signals and to determine a pressure value and a temperature value in the vicinity of the sensor based on these two voltage signals.

2. The measuring system according to claim 1, wherein the Wheatstone bridge comprises two parallel branches, each of the two parallel branches having two of the resistors arranged in series and an intermediate point between the two resistors, the temperature being estimated from a voltage signal across two resistors of the same branch of the two parallel branches and the pressure being estimated from a measurement of a voltage signal between the intermediate points of the two parallel branches.

3. The measuring system according to claim 1, wherein the Wheatstone bridge is fed with current.

4. The measuring system according to claim 1, wherein the resistors are arranged on a deformable membrane.

5. The measuring system according to claim 1, further comprising a nozzle with a cavity, the nozzle being pierced such that the cavity is fluidly connected to an air flow.

6. The measuring system according to claim 1, wherein the at least two pairs of conductors consist of exactly 4 conductors connecting the piezoresistive sensor to the analysis module.

7. The measuring system according to claim 1, wherein the at least two pairs of conductors consist of exactly 6 conductors connecting the piezoresistive sensor to the module of analysis.

8. The measuring system according to claim 7, wherein the 6 connectors are grouped in a common sheath.

9. The measuring system according to claim 1, wherein at least one of the resistors is a thermistor.

10. The measuring system according to claim 1, wherein the system is adapted to be positioned in the vicinity of a leading edge of a stator vane of a turbine engine being tested on a test bench.

11. The measuring system according to claim 1, wherein the measuring system is adapted to be positioned in the vicinity of a leading edge of a stator vane of a turbine engine of a flying aircraft.

12. A measuring system for a turbine engine, the measuring system comprising:
a piezoresistive sensor; and an analysis module;
wherein the piezoresistive sensor comprises:
resistors arranged as a Wheatstone bridge and is configured to deliver two voltage signals, the piezoresistive sensor and the analysis module being connected to each other by at least two pairs of conductors allowing the analysis module to measure the two voltage signals and to determine a pressure value and a temperature value in the vicinity of the piezoresistive sensor based on these two voltage signals; and
a nozzle with a cavity, the nozzle being pierced such that the cavity is fluidly connected to an air flow, wherein the resistors are arranged on a deformable membrane arranged in the cavity.

13. The measuring system according to claim 12, wherein the nozzle has a diameter of less than 3 mm.

14. The measuring system according to claim 12, wherein all the connectors are grouped in a common sheath adapted to be connected to the analysis module.

15. The measuring system according to claim 12, wherein at least one of the resistors is a thermistor.

16. A measuring system for a turbine engine, the measuring system comprising:
a piezoresistive sensor; and
an analysis module;
wherein the piezoresistive sensor comprises:
resistors arranged as a Wheatstone bridge and is configured to deliver two voltage signals, the piezoresistive sensor and the analysis module being connected to each other by exactly six conductors allowing the analysis module to measure the two voltage signals and to determine a pressure value and a temperature value in the vicinity of the piezoresistive sensor based on these two voltages.

17. The measuring system according to claim 16, wherein all of the six connectors are grouped in a common sheath adapted to be connected to the analysis module.

18. The measuring system according to claim 16, wherein the measurements are made sequentially at a rate of between 8 kHz to 100 kHz.
